(19) United States
(12) Patent Application Publication
(10) Pub. No.: US 2025/0182738 A1
(43) Pub. Date: Jun. 5, 2025

(54) SYSTEM AND METHOD FOR PROVIDING CUSTOMIZED PODCASTS

(71) Applicant: Yahoo Assets LLC, New York, NY (US)

(72) Inventor: Paloma de Juan, New York, NY (US)

(21) Appl. No.: 18/528,417

(22) Filed: Dec. 4, 2023

(51) Int. Cl. G10L 13/08; G06F 16/34

(52) U.S. Cl. CPC G10L 13/08; G06F 16/345

(57) ABSTRACT

One or more computing devices, systems, and/or methods for providing customized podcasts are provided. In an example, a request to provide a podcast to a client device is received. The request is indicative of a podcast customizing feature. Based upon the request, a set of content items is determined. A summary of the set of content items is generated based upon the podcast customizing feature. The podcast is generated to comprise an auditory representation of the summary. The podcast is provided to the client device.

### BACKGROUND

Many services, such as websites, applications, etc. may provide platforms for viewing media, such as videos. For example, a user wanting to learn about a topic may need to spend time finding and/or reading various articles about the topic.

### SUMMARY

In accordance with the present disclosure, one or more computing devices and/or methods are provided. In an example, a request to provide a podcast to a client device is received. The request is indicative of a podcast customizing feature. Based upon the request, a set of content items is determined. A summary of the set of content items is generated based upon the podcast customizing feature. The podcast is generated to comprise an auditory representation of the summary. The podcast is provided to the client device.

In an example, a request to provide a podcast to a client device is received. The request is indicative of an article and a podcast customizing feature. A summary of the article is generated based upon the podcast customizing feature. The podcast is generated to comprise an auditory representation of the summary. The podcast is provided to the client device.

In an example, a request to provide a first podcast to a client device is received. The request is indicative of a second podcast and a podcast customizing feature. A summary of the second podcast is generated based upon the podcast customizing feature. The first podcast is generated to comprise an auditory representation of the summary. The first podcast is provided to the client device.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is an illustration of a scenario involving various examples of networks that may connect servers and clients.

FIG. 2 is an illustration of a scenario involving an example configuration of a server that may utilize and/or implement at least a portion of the techniques presented herein.

FIG. 3 is an illustration of a scenario involving an example configuration of a client that may utilize and/or implement at least a portion of the techniques presented herein.

FIG. 4 is a flow chart illustrating an example method for providing users with customized podcasts.

FIG. 5A is a component block diagram illustrating an example system for providing users with customized podcasts, where a first client device displays a content list.

FIG. 5B is a component block diagram illustrating an example system for providing users with customized podcasts, where a first client device displays a first article and a podcast customization interface.

FIG. 5C is a component block diagram illustrating an example system for providing users with customized podcasts, where a first client device displays a first article and a podcast customization interface.

FIG. 5D is a component block diagram illustrating an example system for providing users with customized podcasts, where a first client device displays a first article and a podcast customization interface.

FIG. 5E is a component block diagram illustrating an example system for providing users with customized podcasts, where a request for a customized podcast is received by a content system.

FIG. 5F is a component block diagram illustrating an example system for providing users with customized podcasts, where a summary is generated using a language model based upon a set of content items and/or podcast customizing information.

FIG. 5G is a component block diagram illustrating an example system for providing users with customized podcasts, where text of a summary is converted to speech to generate a customized podcast.

FIG. 5H is a component block diagram illustrating an example system for providing users with customized podcasts, where a content system provides a customized podcast to a first client device.

FIG. 6A is a component block diagram illustrating an example system for providing users with a podcast feed, where a first client device displays a podcast feed customization interface.

FIG. 6B is a component block diagram illustrating an example system for providing users with a podcast feed, where a first client device displays a notification that a podcast of a podcast feed is available.

FIG. 7 is a flow chart illustrating an example method for providing users with customized podcasts.

FIG. 8 is a flow chart illustrating an example method for providing users with customized podcasts.

FIG. 9 is an illustration of a scenario featuring an example non-transitory machine readable medium in accordance with one or more of the provisions set forth herein.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

### 1. Computing Scenario

The following provides a discussion of some types of computing scenarios in which the disclosed subject matter may be utilized and/or implemented.

### 1.1. Networking

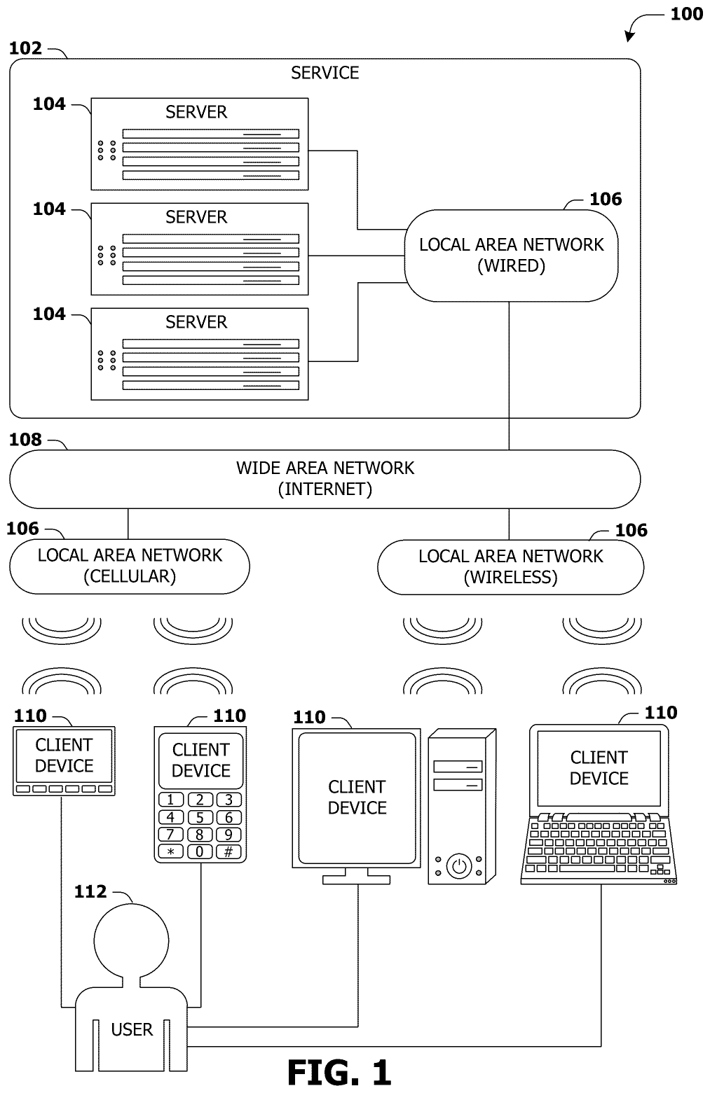

FIG. 1 is an interaction diagram of a scenario 100 illustrating a service 102 provided by a set of servers 104 to a set of client devices 110 via various types of networks. The servers 104 and/or client devices 110 may be capable of transmitting, receiving, processing, and/or storing many types of signals, such as in memory as physical memory states.

The servers 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly, or through one or more other networking devices, such as routers, switches, and/or repeaters. The servers 104 may utilize a variety of physical networking protocols (e.g., Ethernet and/or Fiber Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected; e.g., a router may provide a link between otherwise separate and independent local area networks 106.

In the scenario 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

In the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

### 1.2. Server Configuration

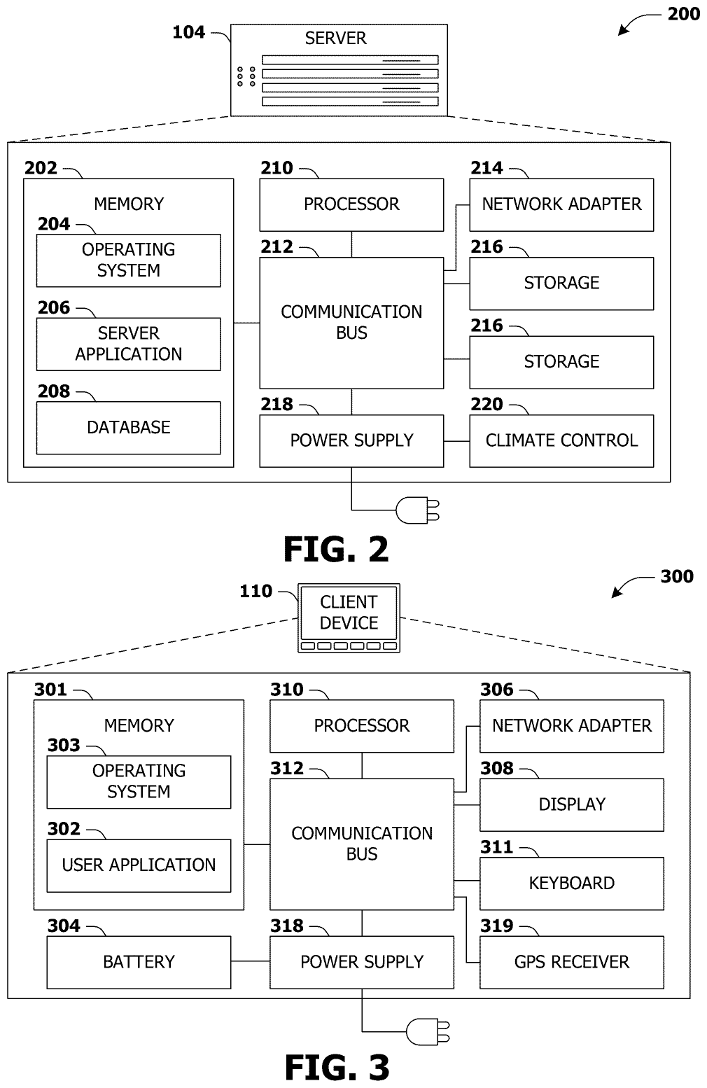

FIG. 2 presents a schematic architecture diagram 200 of a server 104 that may utilize at least a portion of the techniques provided herein. Such a server 104 may vary widely in configuration or capabilities, alone or in conjunction with other servers, in order to provide a service such as the service 102.

The server 104 may comprise one or more processors 210 that process instructions. The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

### 1.3. Client Device Configuration

FIG. 3 presents a schematic architecture diagram 300 of a client device 110 whereupon at least a portion of the techniques presented herein may be implemented. Such a client device 110 may vary widely in configuration or capabilities, in order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device, and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals. The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 319 that detects the location, velocity, and/or acceleration of the client device 110, a compass, accelerometer, and/or gyroscope that detects a physical orientation of the client device 110. Other components that may optionally be included with the client device 110 (though not shown in the schematic architecture diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed webserver may provide web content in response to locally submitted web requests. Many such client devices 110 may be configured and/or adapted to utilize at least a portion of the techniques presented herein.

### 2. Presented Techniques

One or more computing devices and/or techniques for providing users with customized podcasts are provided. A content system, such as a website, an application, etc., may provide a platform for consuming content items including articles, audio (e.g., podcasts, music, etc.) and/or videos. A user may have an interest in a first article, but may prefer listening to an audio version of the first article (rather than reading the first article, for example). In accordance with one or more of the techniques herein, the content system may provide an interface for the user to submit one or more podcast customizing features and/or may generate a customized podcast associated with the first article based upon the one or more podcast customizing features. The one or more podcast customizing features may comprise at least one of target length (e.g., 10 minutes), level of detail, entity of interest, etc. For example, the customized podcast may be generated to have a length that is at most the target length, thereby accounting for the user's time budget and/or background knowledge. Alternatively and/or additionally, the present disclosure may be used to transform a previously recorded podcast (and/or other type of content item) to a customized podcast based upon the one or more podcast customizing features. The customized podcast may preserve speakers' voices of the previously recorded podcast. In some examples, a summary (of the first article and/or the previously recorded podcast, for example) is generated based upon the target length. For example, a target summary length (e.g., 1500 words) of the summary may be determined based upon the target length, and/or the summary may be generated based upon the target summary length (e.g., a length, such as quantity of words, of the summary may be at most the target summary length). The customized podcast may be generated to comprise an auditory representation of the summary. A length of the customized podcast may be at most the target length, such as due, at least in part, to the summary having been generated based upon the target summary length. The first article and/or the previously recorded podcast may be summarized to a degree that yields the customized podcast having a length that is at most the target length, while preserving relevant details of the first article and/or the previously recorded podcast. Some systems rely upon speeding up audio of a podcast to shorten a length of the podcast, which may worsen comprehension of a listener of a podcast and/or may provide worsened audio quality compared to the (original) podcast). In accordance with some embodiments, the customized podcast is generated without increasing a speed of audio of the customized podcast, which may provide for improved comprehension of the customized podcast by the user and/or improved audio quality of the customized podcast.

In some embodiments, the term “podcast” as used in the present disclosure may refer to audio which may comprise speech, music and/or other content.

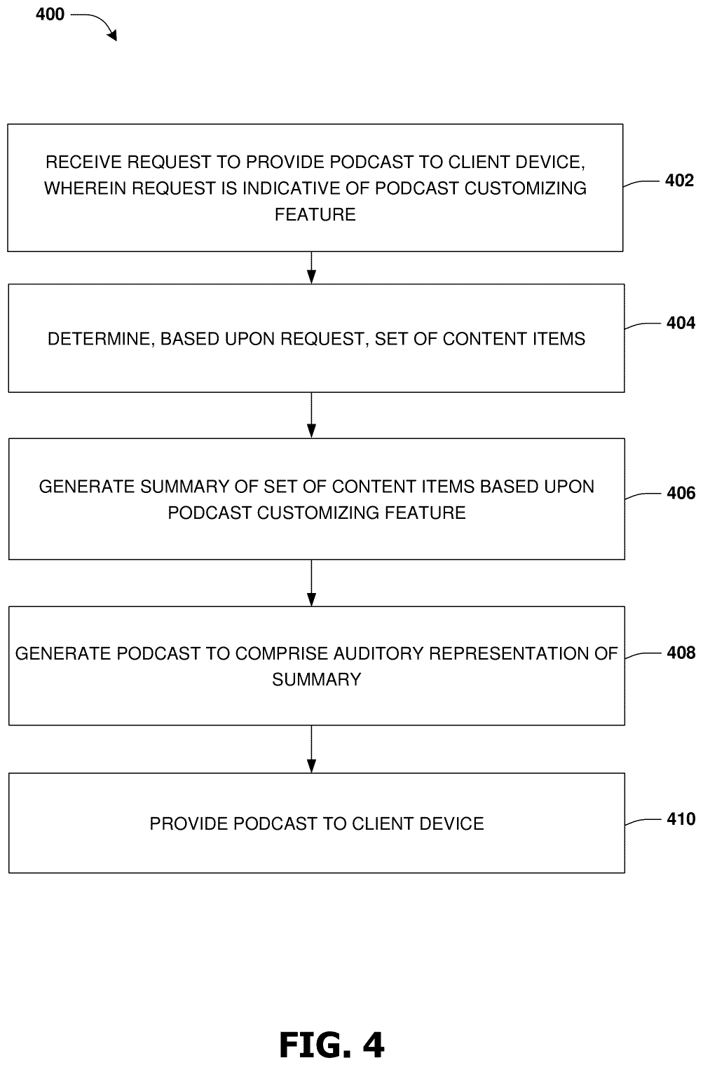

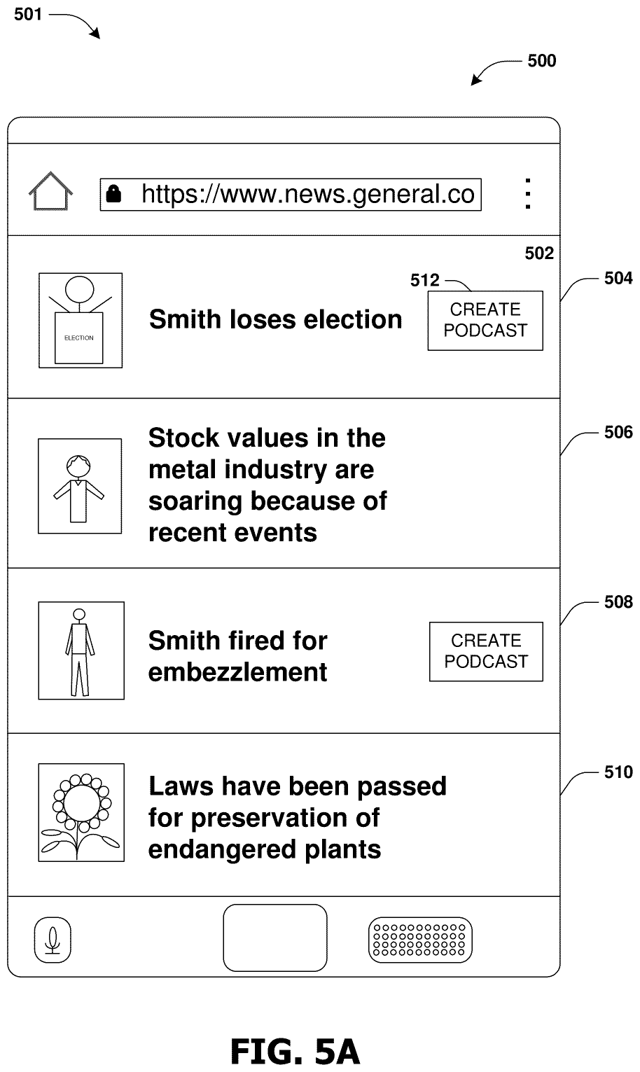

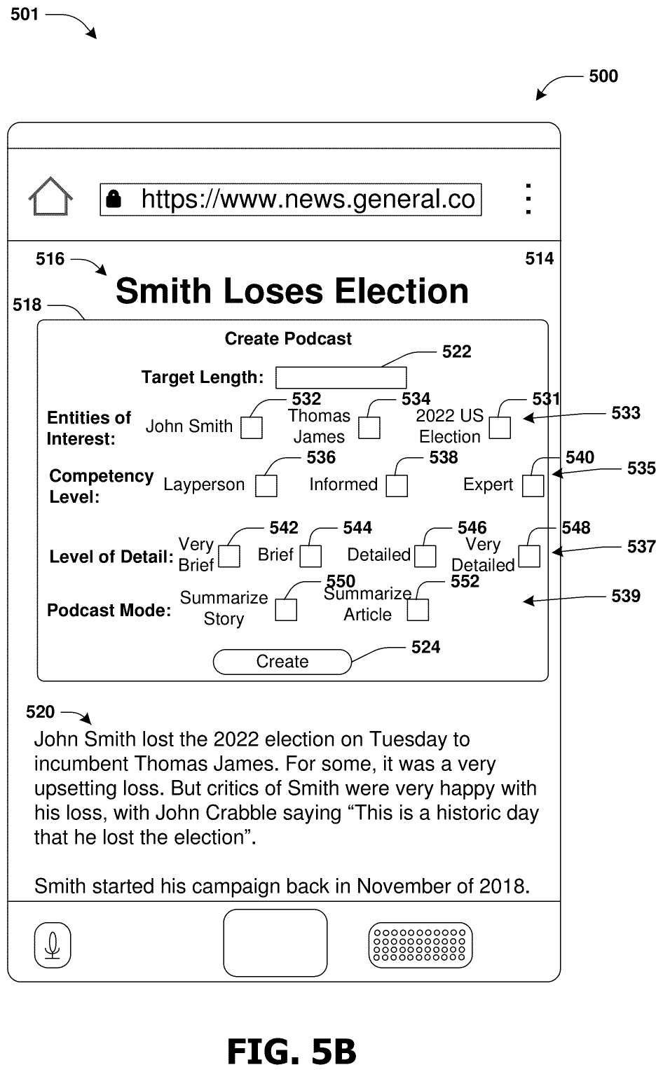

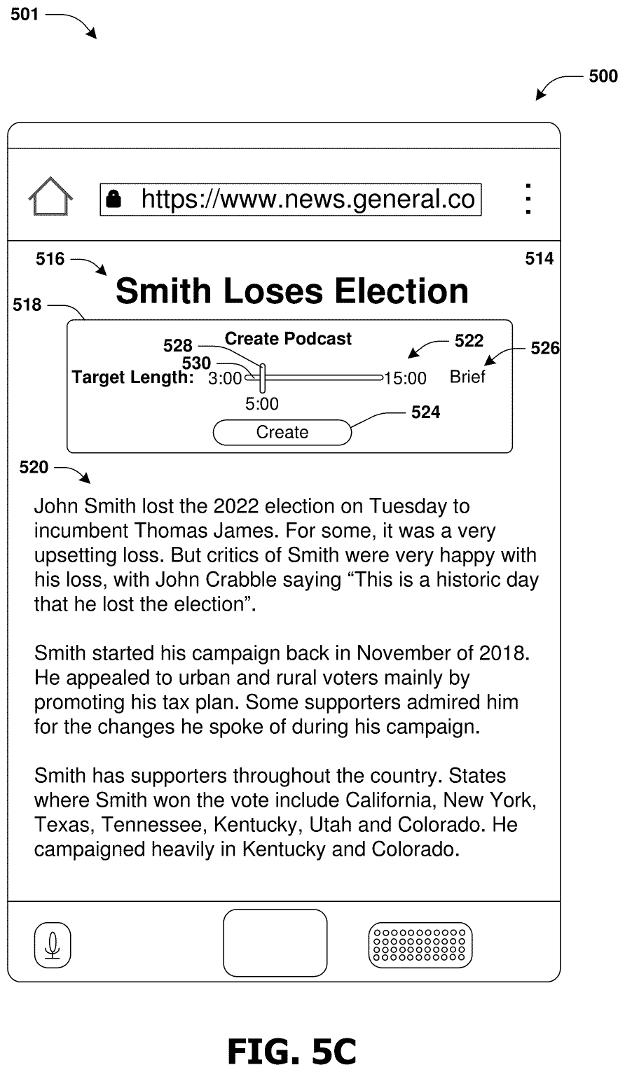

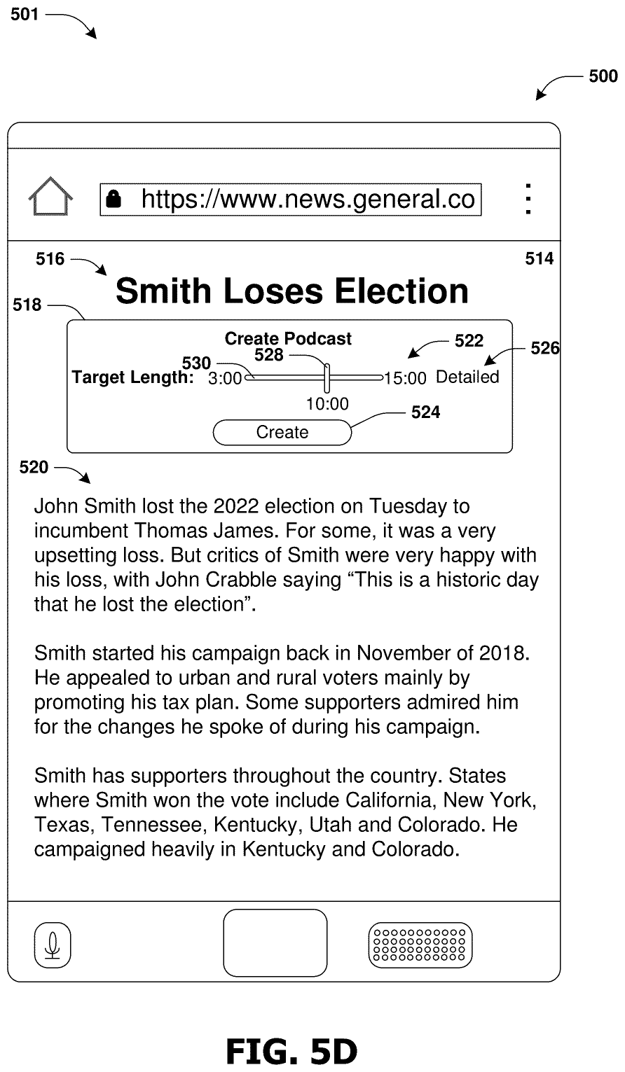

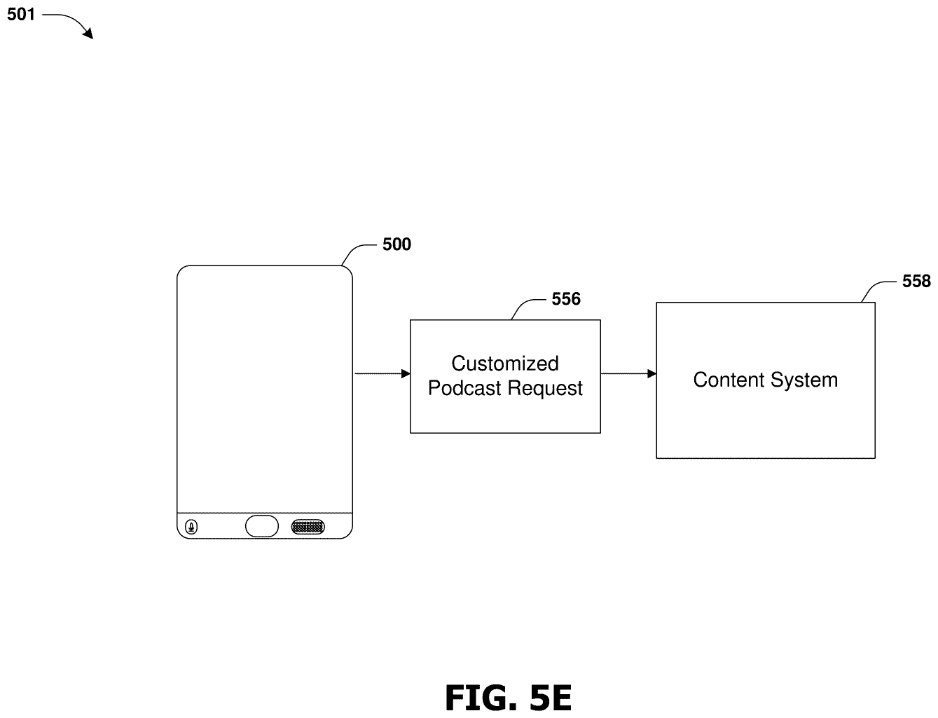

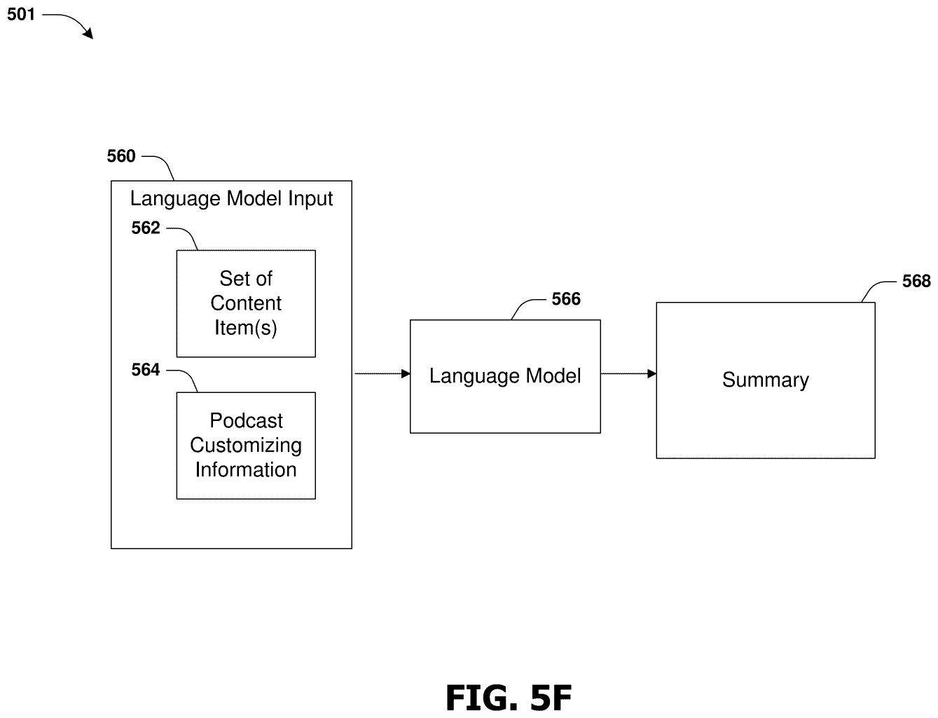

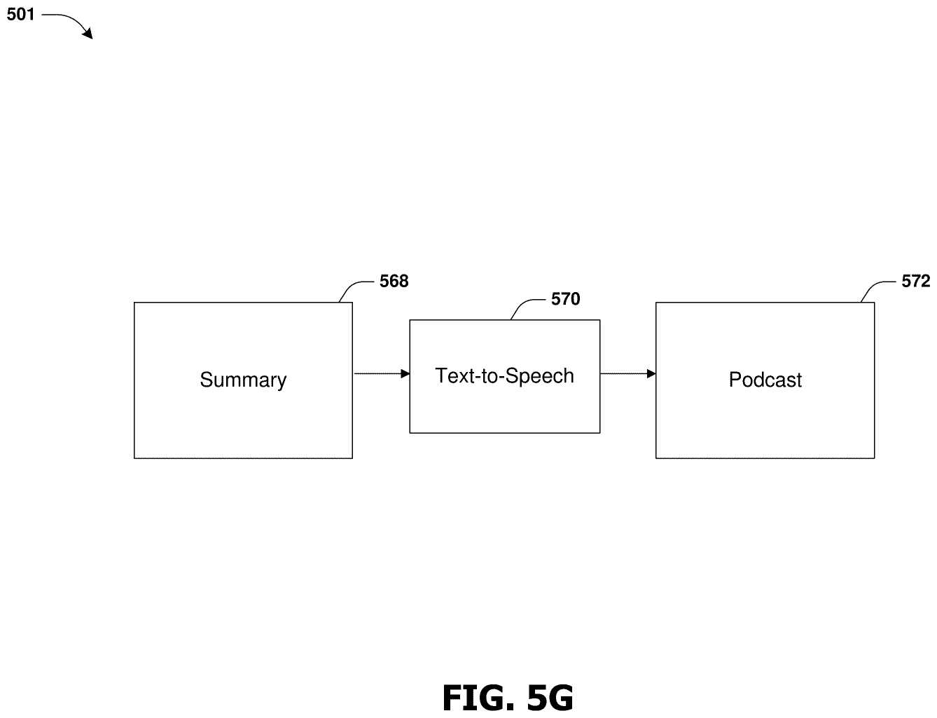

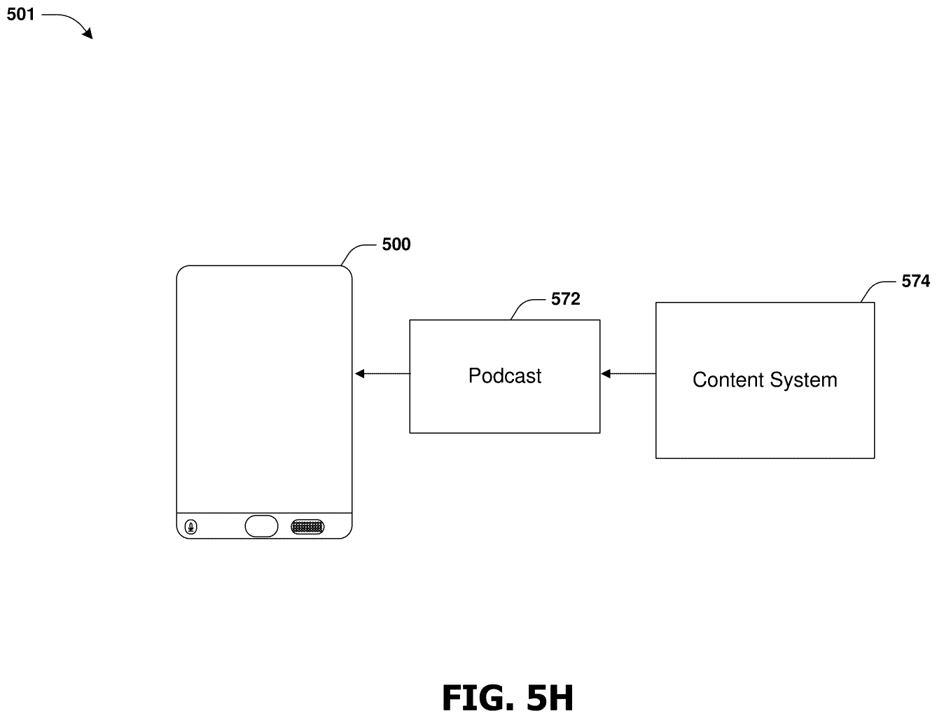

An embodiment of providing users with customized podcasts is illustrated by an example method 400 of FIG. 4, and is further described in conjunction with system 501 of FIGS. 5A-5H. A content system for presenting content via client devices may be provided. For example, client devices may access and/or interact with one or more services, such as one or more web pages, one or more applications, one or more content interfaces, etc. for viewing and/or downloading content items from one or more servers associated with the content system. For example, the content items may comprise at least one of articles (e.g., news articles, educational articles, research papers, sports articles, informational articles, blogs, etc.), video content items, audio content items, etc.

FIG. 5A illustrates an exemplary scenario in which a first client device 500 (e.g., a phone, a laptop, a computer, a wearable device, a smart device, a television, any other type of computing device, hardware and/or software) displays a content list. The content list may be displayed via a web page 502 (provided by the content system, for example). The content list may comprise selectable list items associated with content items. For example, the content items may comprise at least one of articles (e.g., news articles, educational articles, research papers, sports articles, informational articles, blogs, etc.), video content items, audio content items, etc. The selectable list items may comprise a first selectable list item 504 associated with a first article and/or other selectable list items 506, 508 and/or 510 associated with other content items. The first article may comprise at least one of a news article, an educational article, a research paper, a sports article, an informational article, a blog, etc.

In some examples, the content list may comprise one or more podcast objects associated with one or more content items. For example, podcast objects may be displayed for corresponding content items for which the content system (using one or more of the techniques provided herein, for example) offers a customizable podcast service. One or more podcast objects may comprise a first podcast object 512 associated with the first article. For example, the first podcast object 512 may be displayed within and/or overlaying the first selectable list item 504. In some examples, the first podcast object 512 may be a graphical object (such as comprising an image, a symbol and/or text) which indicates that a podcast associated with the first article may be generated and/or provided to users of the content system. Alternatively and/or additionally, the first podcast object 512 may be a selectable input corresponding to displaying a podcast customization interface (e.g., a first podcast customization interface 518) for (i) entering a set of (one or more) podcast customizing features (e.g., target length, level of detail, etc.) of a first customized podcast associated with the first article and/or (ii) submitting a request for the content system to generate and/or provide the first customized podcast.

In some examples, a request to present the first article may be received from the first client device 500. For example, the request may be received responsive to a selection of the first selectable list item 504 associated with the first article (and/or a selection of the first podcast object 512). Responsive to receiving the request to present the first article, the first article and/or the first podcast customization interface 518 may be displayed via the first client device 500. FIG. 5B illustrates the first client device 500 accessing a web page 514 comprising the first article and/or the first podcast customization interface 518. The first client device 500 may access the web a selection of the first podcast object 512). In some examples, the set of podcast customizing features may comprise a first target length, one or more first entities of interest, a first level of detail, a first audience competency level, a first podcast mode and/or one or more other podcast customizing features associated with the first customized podcast. The set of podcast customizing features may be used for customizing the first customized podcast.

In some examples, the first podcast customization interface 518 may be displayed between a title 516 of the first article and a body 520 of the first article. The first podcast customization interface 518 may comprise a target length entry input 522 for submitting an indication of the first target length, an entity of interest interface 533 for submitting an indication of the one or more first entities of interest, a competency level interface 535 for submitting the first audience competency level, a level of detail interface 537 for submitting the first level of detail, a podcast mode interface 539 for submitting the first podcast mode and/or a first selectable input 524 for producing the first customized podcast associated with the first article. The target length entry input 522 may comprise a text field (such as shown in FIG. 5B) that may be used (by a first user of the first client device 500, for example) to enter the first target length of the first podcast. For example, if a desired length of the first podcast is about 10 minutes (e.g., the first user wants the first podcast to be about 10 minutes in length), the first user may enter “10:00” into the text field to indicate that the first target length is 10 minutes.

The entity of interest interface 533 may display indications of a set of related entities (e.g., one or more related entities) determined to be related to the first article. For example, the first article may refer to the set of related entities. In some examples, the set of related entities (e.g., named entities) may correspond to entities comprising at least one of one or more places (e.g., countries, cities, geographic locations, etc.), one or more people (e.g., people of a particular location, people with a particular occupation, politicians, celebrities, socialites, etc.), one or more things (e.g., devices, natural objects, etc.), one or more organizations, one or more companies, one or more stock symbols, one or more ticker symbols, one or more ideas, one or more systems, one or more objects (e.g., one or more abstract objects and/or one or more physical objects), one or more events, one or more historical events, one or more current events, one or more concepts, etc.

In some examples, at least some of the set of related entities may be identified using one or more named-entity recognition (NER) techniques (e.g., entity identification, entity chunking and/or entity extraction). In some examples, at least some of the set of related entities may be identified using one or more informational databases, such as using one or more dictionary-based entity identification techniques. For example, the first article and/or portions of the first article may be compared with one or more resources (e.g., an entity dictionary, a list of entity terms, an encyclopedia, an online encyclopedia, a news channel, a news website, a website, a book, a research article, a research article database and/or a different type of informational database, etc.) to identify the set of related entities.

The entity of interest interface 533 may be used for selecting the one or more first entities of interest from among the set of related entities. In an example, the set of related entities may comprise a first entity corresponding to a candidate named John Smith, a second entity corresponding to a candidate named Thomas James and/or a third entity corresponding to an event (e.g., 2022 United States Election). The entity of interest interface 533 may comprise a checkbox 532 associated with the first entity, a checkbox 534 associated with the second entity, a checkbox 531 associated with the third entity, and/or other checkboxes associated with other entities of the set of related entities. In an example, the first entity (e.g., John Smith) may be included in the one or more first entities of interest based upon a selection of the checkbox 532.

The competency level interface 535 may display indications of a set of competency levels. The competency level interface 535 may be used for selecting the first audience competency level from among the set of competency levels. In an example, the set of competency levels may comprise a competency level “Layperson”, a competency level “Informed”, a competency level “Expert” and/or other competency levels. The competency level interface 535 may comprise a checkbox 536 associated with the competency level “Layperson”, a checkbox 538 associated with the competency level “Informed”, a checkbox 540 associated with the competency level “Expert” and/or other checkboxes associated with other competency levels of the set of competency levels. In an example, the first audience competency level may correspond to the competency level “Layperson” based upon a selection of the checkbox 536.

The level of detail interface 537 may display indications of a set of levels of detail. The level of detail interface 537 may be used for selecting the first level of detail from among the set of levels of detail. In an example, the set of levels of detail may comprise a level of detail “Very Brief”, a level of detail “Brief”, a level of detail “Detailed”, a level of detail “Very Detailed” and/or other levels of detail. The level of detail interface 537 may comprise a checkbox 542 associated with the level of detail “Very Brief”, a checkbox 544 associated with the level of detail “Brief”, a checkbox 546 associated with the level of detail “Detailed”, a checkbox 548 associated with the level of detail “Very Detailed” and/or other checkboxes associated with other levels of detail of the set of levels of detail. In an example, the first level of detail may correspond to the level of detail “Detailed” based upon a selection of the checkbox 546.

The podcast mode interface 539 may display indications of a set of podcast modes. The podcast mode interface 539 may be used for selecting the first podcast mode from among the set of podcast modes. In an example, the set of podcast modes may comprise a podcast mode “Summarize Story”, a podcast mode “Summarize Article” and/or other podcast modes. The podcast mode interface 539 may comprise a checkbox 550 associated with the podcast mode “Summarize Story”, a checkbox 552 associated with the podcast mode “Summarize Article”, and/or other checkboxes associated with other podcast modes of the set of podcast modes. In an example, the first podcast mode may correspond to the podcast mode “Summarize Story” based upon a selection of the checkbox 550.

FIGS. 5C and 5D illustrate the first client device 500 accessing the web page 514 according to an example in which the target length entry input 522 may comprise a slider. The slider may comprise an indicator 528 and/or a bar 530. The first target length may be set to a desired value by moving the indicator 528 to a position of the bar 530 that corresponds to the desired value. In some examples, the first podcast customization interface 518 may comprise an indication of a minimum value (e.g., 3:00) of the first target length, an indication of a maximum value (e.g., 15:00) of the first target length, and/or an indication of a value corresponding to a current position of the indicator 528. In some examples, the first podcast customization interface 518 may comprise an indication 526 of a level of details of the first podcast generated according to the value corresponding to the current position of the indicator 528. In some examples, the level of details may be selected from a plurality of levels including (i) Very Brief, (ii) Brief, (iii) Detailed, and/or (iv) Very Detailed. In some examples, when the value (corresponding to the current position of the indicator 528) is 5:00 (e.g., 5 minutes), such as shown in FIG. 50, the indication 526 may correspond to “Brief”. In some examples, when the value is 10:00, such as shown in FIG. 5D, the indication 526 may correspond to “Detailed”.

Other types of interfaces other than those discussed and/or shown herein may be provided (in the first podcast customization interface 518, for example) to enable a user to submit (a selection of) the set of podcast customizing features.

At 402, a first request to provide the first customized podcast to the first client device 500 may be received (by the content system, for example). FIG. 5E illustrates the first client device 500 transmitting the first request (shown with reference number 556), according to some embodiments. The first request 556 may be received by a server 558 of the content system. In some examples, the first request 556 may be transmitted by the first client device 500 in response to a selection of the first selectable input 524 of the first podcast customization interface 518. The first request 556 may be indicative of the set of podcast customizing features. Alternatively and/or additionally, the first request 556 may be indicative of the first article. Alternatively and/or additionally, the first request 556 may be indicative of an indication of the web page 514 and/or a web address of the web page 514 (e.g., the content system may identify the first article associated with the first request 556 based upon the web page 514 and/or the web address).

At 406, a first set of content items may be determined based upon the first request 556. In some examples, the first set of content items may comprise the first article and/or one or more other content items (e.g., one or more articles, video content items, audio content items, etc.).

In some examples, the first set of content items may be determined based upon the first podcast mode. In some examples, the podcast mode “Summarize Story” may be associated with summarizing a plurality of content items (including the first article, for example) associated with a story (e.g., one or more events and/or one or more entities that are interrelated) at least partially covered by the first article. For example, each content item of the first of content items may cover at least a portion of the story. Thus, in an example in which the first podcast mode is the podcast mode “Summarize Story”, the first set of content items may comprise a plurality of content items (e.g., a plurality of articles and/or other types of content items) associated with the story. In an example in which the story corresponds to John Smith (e.g., the first entity) losing to Thomas James (e.g., the second entity) in the 2022 United States Election (e.g., the third entity), each of the plurality of content items may be associated with the 2022 United States Election, John Smith and/or Thomas James. For example, the content system may (i) analyze a database of content items to identify one or more content items (e.g., the plurality of content items) associated with the story, and/or (ii) retrieve the one or more content items from the database of content items for inclusion in the first set of content items.

In some examples, the podcast mode “Summarize Article” may be associated with summarizing the first article. In an example in which the first podcast mode is the podcast mode “Summarize Article”, the content system may include the first article in the first set of content items (and/or the content system may not include other articles other than the first article in the first set of content items). For example, the first set of content items may comprise the first article (e.g., only the first article) when the first podcast mode is the podcast mode “Summarize Article”.

In some examples, the first set of content items may be determined based upon the first target length and/or the first level of detail. For example, the content system may determine a first amount of content based upon the first target length and/or the first level of detail. In some examples, the first amount of content is a function of the first target length and/or the first level of detail, wherein an increase of the first target length and/or an increase of the first level of detail may correspond to an increase of the first amount of content. The first amount of content may correspond to (and/or may be based upon) a quantity of words and/or characters, a quantity of content items, etc. In some examples, the content system may determine the first set of content items based upon the first amount of content. For example, the content system may determine (e.g., select) the first set of content items such that an amount of content of the first set of content items does not exceed the first amount of content (and/or does not exceed the first amount of content by a threshold amount). In some examples, the content system includes at least the first article in the first set of content items (even if an amount of content in the first article exceeds the first amount of content, for example). In some examples, when the amount of content in the first article does not exceed the first amount of content, the content system may include one or more other content items in the first set of content items (e.g., the one or more other content items may be retrieved from the database of content items).

In some examples, the first set of content items may be determined based upon the one or more first entities of interest. For example, the content system may (i) analyze the database of content items to identify one or more content items associated with an entity of interest (e.g., John Smith) of the one or more first entities of interest, and/or (ii) retrieve the one or more content items from the database of content items for inclusion in the first set of content items. For example, a content item may be included in the first set of content items based upon a determination that the content item comprises first information associated with the entity of interest.

In some examples, the first set of content items may be determined based upon the first audience competency level. In some examples, the first audience competency level may correspond to a level of knowledge and/or understanding that an audience (e.g., the first user of the first client device 500) has in relation with one or more topics of the first article and/or the first customized podcast. For example, the first audience competency level may be “Layperson” when the first user has a first level of knowledge and/or understanding of the one or more topics of the first article and/or the first customized podcast. Alternatively and/or additionally, the first audience competency level may be “Informed” when the first user has a second level of knowledge and/or understanding (greater than the first level of knowledge and/or understanding) of the one or more topics of the first article and/or the first customized podcast. Alternatively and/or additionally, the first audience competency level may be “Expert” when the first user has a third level of knowledge and/or understanding (greater than the second level of knowledge and/or understanding) of the one or more topics of the first article and/or the first customized podcast.

In some examples, the database of content items may include content items associated with different audience competency levels. For example, the database of content items may comprise beginner-level content items associated with the “Layperson” competency level, intermediate-level content items associated with the “Informed” competency level, and/or advanced-level content items associated with the “Expert” competency level. Compared with the intermediate-level content items and/or the advanced-level content items, the beginner-level content items may offer (i) more concise description of the one or more topics, (ii) fewer specific technical concepts, (iii) simpler language and/or terms (e.g., simplified language without technical terms a layperson would not understand), etc. Compared with the beginner-level content items, the intermediate-level content items may offer (i) more technical information about the one or more topics, (ii) more specific technical concepts, (iii) more advanced language and/or terms (e.g., use of some technical terms that an informed person would understand), etc. Compared with the beginner-level content items and/or the intermediate-level content items, the advanced-level content items may offer (i) more technical information about the one or more topics, (ii) more specific technical concepts, (iii) more advanced language and/or terms, etc.

In some examples, the content system may (i) analyze the database of content items to identify one or more content items associated with the first audience competency level, and/or (ii) retrieve the one or more content items from the database of content items for inclusion in the first set of content items. In an example in which the first audience competency level is “Layperson”, the one or more content items (that are included in the first set of content items) may include one or more beginner-level content items.

At 406, the content system may generate a summary of the first set of content items based upon the set of podcast customizing features. FIG. 5F illustrates a language model 566 being used to generate the summary (shown with reference number 568). For example, the content system may submit an input 560 to the language model 566, which may use the input 560 to generate the summary 568. In an example, the input 560 may comprise the first set of content items (shown with reference number 562) and/or podcast customizing information 564 associated with the set of podcast customizing features. In some examples, the podcast customizing information 564 may comprise (and/or may be based upon) one, some and/or all of the set of podcast customizing features. In an example, the language model 566 may summarize the first set of content items 562, based upon the podcast customizing information 564, to generate the summary 568.

In an example, the language model 566 may comprise a large language model. The language model 566 may comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc. In some examples, the language model 566 may be trained using a corpus (e.g., a text corpus). In some examples, the language model 566 comprises a knowledge base (e.g., a database of resources) comprising at least one of one or more dictionaries, one or more lists of terms, one or more encyclopedias, one or more online encyclopedias, one or more news channel resources, one or more news websites, one or more websites, one or more books, one or more research articles, one or more research article databases, one or more informational databases, etc.

In some examples, the content system may determine a target summary length of the summary 568 based upon the first target length and/or the first level of detail. In an example, the target summary length may correspond to a target quantity of words of the summary 568, a target quantity of characters of the summary 568, etc. In some examples, the target summary length may be a function of the first target length and/or the first level of detail, wherein an increase of the first target length and/or an increase of the first level of detail may correspond to an increase of the target summary length. In some examples, the target summary length may be determined based upon a combination of (e.g., a product of) the first target length (e.g., a target length of the first customized podcast) and/or a recitation speed. In an example in which the first target length is about 5 minutes and/or the recitation speed is about 150 words per minute, the target summary length may be determined to be about 150×5=750 words. Thus, in the example, the summary 568 may be generated to have a length of about 750 words (and/or a length of at most about 750 words) based upon the target summary length indicating 750 words. Alternatively and/or additionally, the summary 568 may be generated to have a length of at most about 750 words based upon the target summary length indicating 750 words. The target summary length may be submitted to the language model 566 such that the language model 566 generates the summary 568 according to the target summary length. For example, the podcast customizing information 564 may comprise an indication of the target summary length.

Alternatively and/or additionally, the language model 566 may generate the summary 568 based upon the first podcast mode. In an example in which the first podcast mode corresponds to the podcast mode “Summarize Story”, the language model 566 may generate the summary 568 based upon content items (associated with the story) other than the first article (and based upon the first article, for example). In an example in which the first podcast mode corresponds to the podcast mode “Summarize Article”, the language model 566 may generate the summary 568 based upon the first article (e.g., only the first article and/or only the first article and the knowledge base).

Alternatively and/or additionally, the language model 566 may generate the summary 568 based upon the one or more first entities of interest. In an example, the language model 566 may generate the summary 568 to focus on the one or more first entities of interest. For example, based upon the one or more first entities of interest comprising the first entity and not comprising the second entity, the language model 566 may generate the summary 568 to include more information about the first entity (e.g., John Smith) than the second entity (e.g., Thomas James). Alternatively and/or additionally, a set of text indicative of at least some of the first information associated with the entity of interest (of the one or more first entities of interest) may be included in the summary 568.

Alternatively and/or additionally, the language model 566 may generate the summary 568 based upon the first audience competency level. In an example, in comparison with the competency level “Informed” and/or the competency level “Expert”, if the first audience competency level corresponds to the competency level “Layperson”, the language model 566 may generate the summary 568 to include (i) an increased amount of simple language (e.g., simplified language without technical terms a layperson would not understand), (ii) a reduced amount of technical language (e.g., reduced complex terms), (iii) an increased amount of definitions of concepts and/or terms, etc. For example, concepts and/or terms may be more clearly defined in the summary 568 for the competency level “Layperson”, whereas fewer (and/or briefer) definitions for the concepts and/or terms may be included in the summary 568 for the competency level “Informed” and/or the competency level “Expert” (since an informed and/or expert audience may have a better understanding of the concepts and/or the terms than a layperson, for example).

In some examples, the summary 568 comprises an expansion of the first article and/or the first set of content items 562. For example, the summary 568 may comprise supplemental information in addition to information provided in the first article and/or the first set of content items 562. For example, the supplemental information may be derived from the knowledge base of the language model 566, and/or may be retrieved from other content items determined to be related to the first article, the first set of content items 562 and/or the one or more first entities of interest. The supplemental information may be added to the summary 568 based upon a determination that the supplemental information is about the one or more first entities of interest (and/or one or more other entities associated with the first article).

At 408, the content system may generate the first customized podcast to comprise an auditory representation of the summary 568. FIG. 5G illustrates a text-to-speech converter 570 being used to generate the summary 568. For example, the content system may submit the summary 568 to the text-to-speech converter 570, which may convert text of the summary 568 to the auditory representation of the summary 568 included in the first customized podcast. Thus, in some embodiments, the first customized podcast may comprise the summary 568 being recited vocally using one or more speaker profiles. In some examples, the first customized podcast may comprise speech with merely a single speaker profile. A speaker profile may correspond to one or more characteristics (e.g., speech characteristics) of speech, such as at least one of volume, pitch, frequency, gender, accent, etc. of speech. Alternatively and/or additionally, the first customized podcast may comprise speech with multiple speaker profiles (corresponding to multiple speakers, for example). For example, the first customized podcast may comprise (i) a first audio segment in which a first portion of the summary 568 is recited audibly using a first speaker profile (e.g., a male with a first accent), (ii) a second audio segment in which a second portion of the summary 568 is recited audibly using a second speaker profile (e.g., a female with a second accent), etc. In some examples, a length of the first customized podcast is about the first target length (and/or the length of the first customized podcast is at most about the first target length), such as due, at least in part, to the first customized podcast being generated using the summary 568 which is generated based upon the first summary length.

At 410, the content system may provide the first customized podcast to the first client device 500. FIG. 5H illustrates a server 574 of the content system transmitting the first customized podcast (shown with reference number 572) to the first client device 500. In some examples, the first client device 500 may display a podcast interface for playing the first customized podcast 572. The podcast interface may be displayed via the web page 514, the first podcast customization interface 518, and/or a different interface. In some examples, audio of the first customized podcast 572 (e.g., the auditory representation of the summary 568) may be output via at least one of a loudspeaker of the first client device 500, a set of headphones connected to the first client device 500, etc.

In some examples, after a first portion of the first customized podcast 572 is played (and/or while the first customized podcast 572 is playing on the first client device 500), the content system may receive a podcast update request to provide the first user with an updated podcast (about the first article and/or the story, for example). For example, after listening to the first portion of the first customized podcast 572, the first user may have a desire to change at least some of the set of podcast customizing features. The first user may submit (via the first podcast customization interface 518, for example) an updated set of podcast customizing features. The podcast update request may be indicative of the updated set of podcast customizing features and/or the first article. In some examples, the podcast update request may be received via a voice command (by the first user, for example) captured using a microphone of the first client device 500.

In an example, the first user may desire to listen a podcast that provides more advanced (and/or technical) terms (e.g., the first user may deem terms used in the first customized podcast 572 to be too basic). In the example, the first competency level may be changed from the competency level “Layperson” to the competency level “Informed” and/or the competency level “Expert”. For example, the set of podcast customizing features (used to generate the first customized podcast 572) may indicate the competency level “Layperson”, whereas the updated set of podcast customizing features may be indicative of the competency level “Informed” and/or the competency level “Expert” (to provide for more advanced and/or technical terms, for example). In some examples, in response to the podcast update request, the content system may generate an updated customized podcast based upon the updated set of podcast customizing features, such as using one or more of the techniques provided herein with respect to generating the first customized podcast 572. Alternatively and/or additionally, the content system may generate the updated customized podcast based upon the first portion of the first customized podcast 572 that was already played and/or listened to. For example, the content system may identify information included in the first portion of the first customized podcast 572 (which was already listened to by the first user, for example), and/or may exclude the information from the updated customized podcast (so as to avoid repeating the same information to the first user, for example). In some examples, the content system may provide the updated customized podcast to the first client device 500 and/or may play the updated customized podcast on the first client device 500 (e.g., the updated customized podcast may be output via the loudspeaker, the set of headphones, etc.).

In some examples, the set of podcast customizing features may comprise a target language (e.g., English, French, German, Mandarin, etc.). In some examples, the first set of content items 562 may comprise one or more first content items having a second language different than the target language and/or one or more second content items having the target language. In an example, the target language may be German, and one or more of the first set of content items 562 may be in languages other than German, such as at least one of English, French, Mandarin, etc. The first user may have at least some proficiency in German (e.g., the first user may be fluent in German and/or may be learning German). The second language of the one or more second content items may be English. For example, the one or more second content items may include at least one of an article written and/or published in English, a podcast with English-language speakers and/or speech in English, a video with English-language speakers and/or speech in English, etc. The one or more first content items (e.g., text and/or a transcript of the one or more first content items) may be translated (e.g., automatic English to German translation) to the target language to generate one or more translated content items. In some examples, the one or more translated content items and the one or more second content items are used to generate the summary 568 in the target language. For example, the one or more translated content items and the one or more second content items may be input to the language model 566, which may generate the summary 568 in the target language based upon the one or more translated content items, the one or more second content items, and/or the set of podcast customizing features. The summary 568 (in the target language) may be used to generate the first customized podcast 572 (such that the first user can listen to the first customized podcast 572 in the target language, for example). Alternatively and/or additionally, the summary 568 may be generated to have the second language. The summary 568 may be translated to the target language to generate a translated summary, which may be used to generate the first customized podcast 572 (in the target language). In some examples, the first customized podcast 572 in the target language (e.g., German) may be generated in a manner that (i) preserves (in a first portion of the first customized podcast 572, for example) a first voice of a first speaker in a first content item (of the first set of content items 562) in the second language (e.g., English), (ii) preserves (in a second portion of the first customized podcast 572, for example) a second voice of a second speaker in a second content item (of the first set of content items 562) in another language (e.g., Mandarin), and/or (iii) preserves (in one or more other portions of the first customized podcast 572, for example) one or more other voices of one or more other speakers in one or more other content items (of the first set of content items 562) in one or more other languages (e.g., French, Spanish, Portuguese, etc.).

Embodiments are contemplated in which the first article (used to generate the first customized podcast 572, for example) is replaced with another type of content item, such as at least one of audio (e.g., a podcast), a video, etc. In some examples, a transcript of at least one of the audio, the video, etc. is determined, such as using one or more automated speech recognition (ASR) techniques. The transcript may be included in the input 560 submitted to the language model 566 for generation of the summary 568.

Alternatively and/or additionally, the first set of content items 562 may comprise an article and/or a content item comprising at least one of audio (e.g., a podcast), a video, etc. In some examples, a transcript of at least one of the audio, the video, etc. is determined (e.g., using one or more ASR techniques). The transcript may be included in the input 560 submitted to the language model 566 for generation of the summary 568.

In some examples, the first request 556 may comprise a podcast feed request to provide the first user (and/or the first client device 500 and/or a first user account of the first user) with a podcast feed (e.g., customized podcast feed). For example, the podcast feed may include recurring podcasts provided to the first user (and/or the first client device 500 and/or the first user account). In some examples, the content system may generate podcasts (e.g., customized podcasts) of the podcast feed based upon the podcast feed request. In some examples, podcasts of the podcast feed may be generated and/or provided to the first user (and/or the first client device 500 and/or the first user account) periodically (e.g., once per day, once per weekday, once per week, etc.).

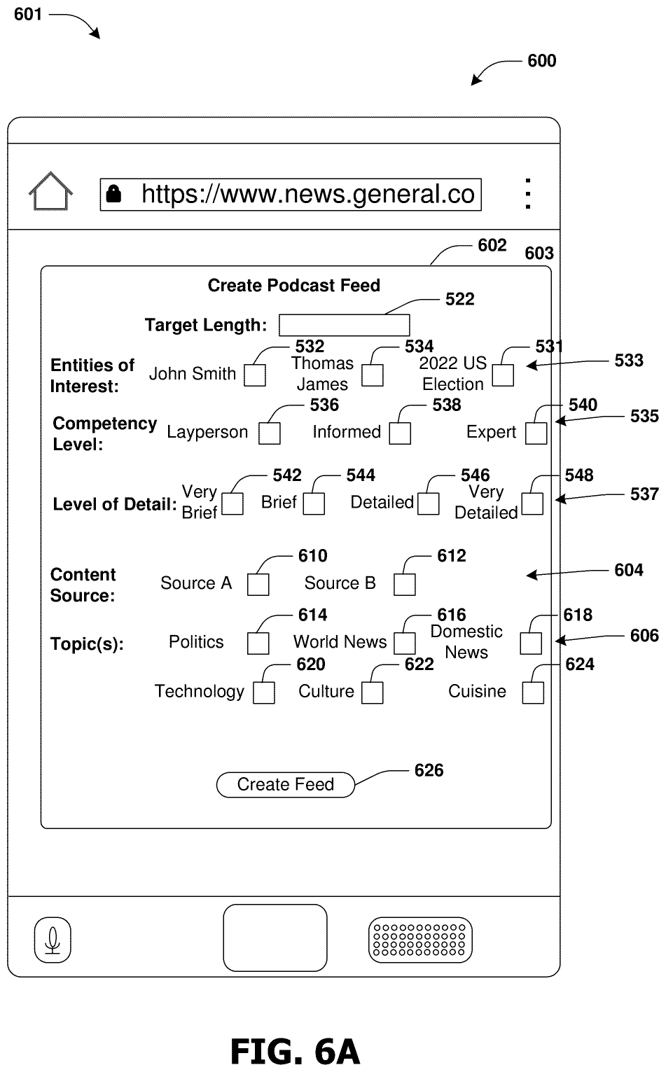

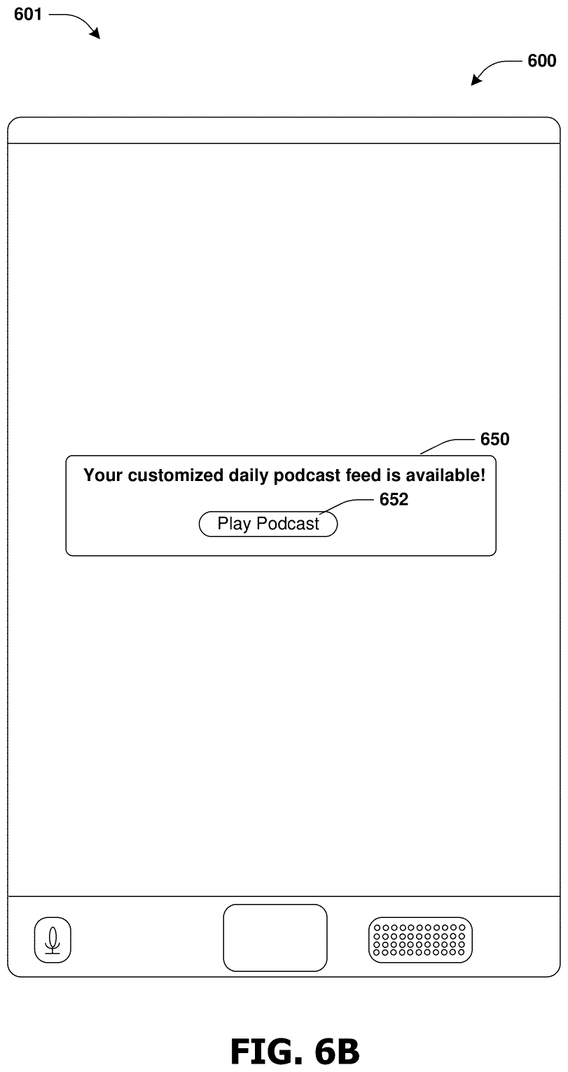

FIGS. 6A-6B illustrates a system 601 for providing users with podcast feeds. FIG. 6A illustrates the first client device 500 displaying a podcast feed customization interface 602. The podcast feed customization interface 602 may be displayed via a web page 603. The podcast feed customization interface 602 may comprise the target length entry input 522 for submitting an indication of a target length of podcasts of the podcast feed, the entity of interest interface 533 for submitting an indication of one or more entities of interest for podcasts of the podcast feed, the competency level interface 535 for submitting an audience competency level for podcasts of the podcast feed, the level of detail interface 537 for submitting a level of detail for podcasts of the podcast feed, a content source interface 604 for submitting an indication of one or more sources of content to use for generating podcasts of the podcast feed, a topic interface 606 for submitting an indication of one or more topics of the podcast feed, and/or a selectable input 626 for configuring the podcast feed.

The content source interface 604 may display indications of a set of sources. The content source interface 604 may be used for selecting one or more first sources from among the set of sources. Each source of the set of sources may correspond to a source of content, such as at least one of (i) a publisher of content, (ii) a website that hosts content, (iii) a news organization that provides news articles and/or podcasts, (iv) a database that provides content, etc. In an example, the set of sources may comprise a source “Source A” (e.g., a first publisher, a first website, a first news organization, a first database, etc.), a source “Source B” (e.g., a second publisher, a second website, a second news organization, a second database, etc.) and/or other sources. The content source interface 604 may comprise a checkbox 610 associated with the source “Source A”, a checkbox 612 associated with the source “Source B”, and/or other checkboxes associated with other sources of the set of sources. In an example, the one or more first sources may comprise the source “Source A” based upon a selection of the checkbox 612.

The topic interface 606 may display indications of a set of topics. The topic interface 606 may be used for selecting one or more first topics from among the set of topics. In an example, the set of topics may comprise a topic “Politics”, a topic “World News”, a topic “Domestic News”, a topic “Technology”, a topic “Culture”, a topic “Cuisine” and/or other topics. The topic interface 606 may comprise a checkbox 614 associated with the topic “Politics”, a checkbox 616 associated with the topic “World News”, a checkbox 618 associated with the topic “Domestic News”, a checkbox 620 associated with the topic “Technology”, a checkbox 622 associated with the topic “Culture”, a checkbox 624 associated with the topic “Cuisine”, and/or other checkboxes associated with other topics of the set of topics. In an example, the one or more first topics may comprise the topic “Politics” based upon a selection of the checkbox 612.

The podcast feed request may be indicative of a set of podcast feed customizing features comprising at least one of the first target length, the one or more first entities of interest, the first level of detail, the first audience competency level, the one or more first sources (e.g., “Source A” and/or “Source B”), the one or more first topics and/or one or more other podcast feed customizing features associated with the podcast feed.

In some examples, at a first time, the content system generates a second customized podcast of the podcast feed using a second set of (one or more) content items (e.g., one or more articles, video content items, audio content items, etc.) from the one or more first sources. For example, the content system may analyze content items of the one or more first sources to identify the second set of content items. The second set of content items may be retrieved from the one or more first sources (and/or may be selected for use in generating the second customized podcast based upon a determination that the second set of content items are associated with the one or more first topics. Thus, if the one or more first topics include the topic “Politics”, the second set of content items may comprise one or more content items about politics. The content system may generate the second customized podcast based upon the second set of content items and/or the set of podcast feed customizing features using one or more of the techniques provided herein with respect to generating the first customized podcast 572, such as by generating a summary based upon the second set of content items, and/or generating the second customized podcast using the summary (e.g., converting text of the summary to audio of the second customized podcast using the text-to-speech converter 570). In some examples, in response to generating the second customized podcast, the content system may (i) provide the second customized podcast to the first client device 500, and/or (ii) provide a notification 650, to the first client device 500, indicating that the second customized podcast of the podcast feed is available to listen to. FIG. 6B illustrates the first client device 500 displaying the notification 650, which may comprise a selectable input 652 to play the second customized podcast.

In some examples, at a second time after the first time, the content system generates a third customized podcast of the podcast feed using a third set of (one or more) content items (e.g., one or more articles, video content items, audio content items, etc.) from the one or more first sources. For example, the content system may analyze content items of the one or more first sources to identify the third set of content items. The third set of content items may be retrieved from the one or more first sources (and/or may be selected for use in generating the third customized podcast based upon a determination that the third set of content items are associated with the one or more first topics. The content system may generate the third customized podcast based upon the third set of content items and/or the set of podcast feed customizing features using one or more of the techniques provided herein with respect to generating the first customized podcast 572. In some examples, the third set of content items may comprise one or more content items (e.g., articles, videos, audio, etc.) that are published and/or released after the second set of content items, and thus may comprise more current information (e.g., information about more recent news) than the second set of content items. Thus, the first user may use podcasts of the podcast feed to catch up on recent news.

In an example in which the podcast feed corresponds to a daily morning news feed, the first time may be Monday morning, the second time may be Tuesday morning, etc. In an example in which the podcast feed corresponds to a weekly news feed, the first time may be Monday of a first week, the second time may be Monday of a second week after the first week, etc. In some examples, podcasts of the podcast feed may be generated and/or provided to the first client device 500 (periodically, for example) until a request to cancel the podcast feed is received.

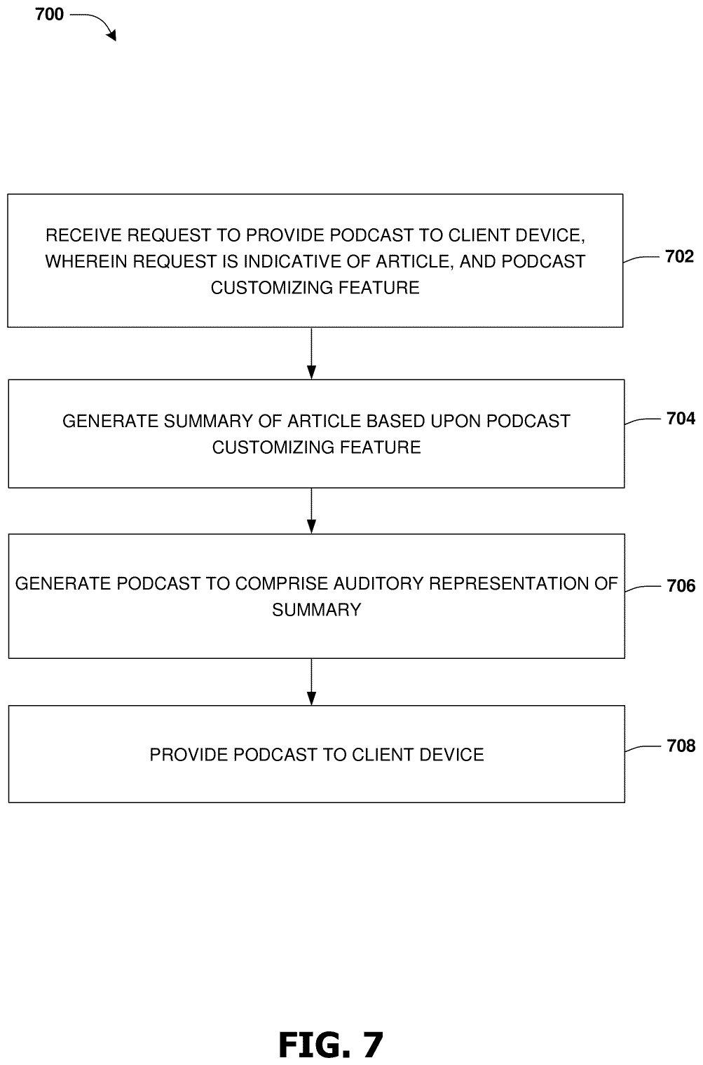

An embodiment of providing users with customized podcasts is illustrated by an example method 700 of FIG. 7. At 702, a request to provide a customized podcast to a client device is received. The request is indicative of an article and one or more podcast customizing features. At 704, a summary of the article is generated based upon the one or more podcast customizing features. The one or more podcast customizing features may comprise a target length, one or more entities of interest, a level of detail, an audience competency level, a podcast mode and/or one or more other podcast customizing features associated with the customized podcast. At 706, the customized podcast is generated to comprise an auditory representation of the summary. At 708, the customized podcast is provided to the client device. In some examples, one, some and/or all acts of example method 700 may be performed using one or more of the techniques provided herein with respect to the example method 400 of FIG. 4, the example system 501 of FIGS. 5A-5H and/or the example system 601 of FIGS. 6A-6B.

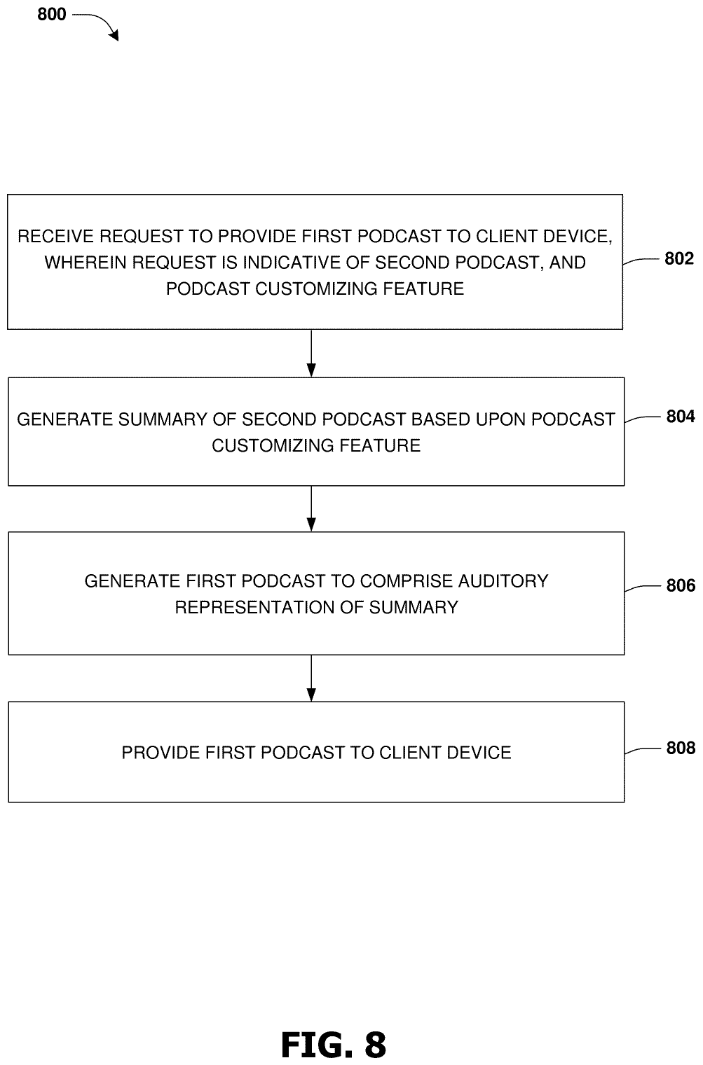

An embodiment of providing users with customized podcasts is illustrated by an example method 800 of FIG. 8. At 802, a request to provide a customized podcast to a client device is received. The request is indicative of a second podcast (e.g., an original and/or readily available podcast) and one or more podcast customizing features. For example, the request may be received via a podcast interface used (by a user of the client device, for example) to access the second podcast (e.g., the user may download and/or listen to the second podcast using the podcast interface). The podcast interface may comprise a podcast customization interface (e.g., the first podcast customization interface 518) for submitting the one or more podcast customizing features. At 804, a first summary of the second podcast is generated based upon the one or more podcast customizing features. The one or more podcast customizing features may comprise a target length, one or more entities of interest, a level of detail, an audience competency level, a podcast mode and/or one or more other podcast customizing features associated with the customized podcast.

In some examples, audio of the second podcast is converted to a transcript. In some examples, the transcript may be indicative of speech spoken by one or more speakers in the second podcast. In an example, the transcript may be determined using one or more automated speech recognition (ASR) techniques (e.g., ASR may be performed on the second podcast to determine the transcript) and/or one or more other techniques. In some examples, the transcript may be indicative of speakers associated with various text segments of the transcript. For example, the content system may identify speakers in the second podcast, and/or may map corresponding dialog to identities of the speakers. For example, a first portion of the transcript may be generated from a first portion of the second podcast in which a first speaker speaks (e.g., the first portion of the transcript may be indicative of speech spoken by the first speaker in the first portion of the second podcast). The first speaker may be a host, a guest, etc. of the second podcast. The transcript may indicate that the first portion of the transcript is associated with the first speaker. A second portion of the transcript may be generated from a second portion of the second podcast in which a second speaker speaks (e.g., the second portion of the transcript may be indicative of speech spoken by the second speaker in the second portion of the second podcast). The second speaker may be a host, a guest, etc. of the second podcast. The transcript may indicate that the second portion of the transcript is associated with the second speaker. In an example, the second podcast may comprise an interview between the first speaker and the second speaker.

In some examples, the language model 566 may generate the first summary based upon the transcript and/or the one or more podcast customizing features. In an example, the language model 566 may generate the first summary according to the one or more podcast customizing features (using one or more of the techniques provided herein with respect to generating the summary 568 associated with the first article based upon the set of podcast customizing features, for example). For example, an input comprising the transcript and/or the one or more podcast customizing features may be submitted to the language model 566, which may generate the first summary based upon the input. For example, the first summary may be generated based upon the target length, the one or more entities of interest, the level of detail, the audience competency level, the podcast mode and/or one or more other podcast customizing features associated with the customized podcast.

At 806, the customized podcast is generated to comprise an auditory representation of the first summary. At 808, the customized podcast is provided to the client device. In some examples, the first summary (generated at act 804, for example) may be indicative of speakers associated with various text segments of the first summary. For example, a first text segment of the first summary may be derived from the first portion, of the transcript, associated with the first speaker. The first summary may comprise an indication that the first text segment is associated with the first speaker. Alternatively and/or additionally, a second text segment of the first summary may be derived from the second portion, of the transcript, associated with the second speaker. The first summary may comprise an indication that the second text segment is associated with the second speaker. In some examples, a third speaker profile may be assigned to one or more first text segments (e.g., the first text segment) associated with the first speaker and/or a fourth speaker profile may be assigned to one or more second text segments (e.g., the second text segment) associated with the second speaker. The third speaker profile may be different from the fourth speaker profile to provide different voices in the customized podcast. In some examples, the third speaker profile may be based upon (and/or may be generated to match) one or more characteristics (e.g., speech characteristics) of speech of the first speaker, such as at least one of volume, pitch, frequency, gender, accent, etc. of speech of the first speaker.

In some examples, the customized podcast is generated to include different speaker profiles (e.g., different voices) for different parts of the customized podcast. For example, the customized podcast may comprise an auditory representation of the first text segment being spoken with the third speaker profile, which may match a voice of the first speaker (e.g., to a listener, at least some of the auditory representation may sound like the first speaker is speaking). Alternatively and/or additionally, the fourth speaker profile may be based upon (and/or may be generated to match) one or more characteristics (e.g., speech characteristics) of speech of the second speaker, such as at least one of volume, pitch, frequency, gender, accent, etc. of speech of the second speaker. For example, the customized podcast may comprise an auditory representation of the second text segment being spoken with the fourth speaker profile, which may match a voice of the second speaker (e.g., to a listener, at least some of the auditory representation sounds like the second speaker is speaking). In some examples, a voice cloning function is performed such that the third speaker profile matches the voice of the first speaker and/or the fourth speaker profile matches the voice of the second speaker. Thus, in accordance with some embodiments, the customized podcast may comprise a summarized version of the second podcast while maintaining one or more speakers' voices from the second podcast.

In some examples, one, some and/or all acts of example method 800 may be performed using one or more of the techniques provided herein with respect to the example method 400 of FIG. 4, the example system 501 of FIGS. 5A-5H and/or the example system 601 of FIGS. 6A-6B.

In some examples, one, some and/or all of the one or more acts provided herein (such as performed by the content system and/or other system) may be performed automatically (and/or without manual user intervention) to generate a customized podcast and/or provide a user with the customized podcast.

It may be appreciated that the disclosed subject matter may assist a user (e.g., and/or a client device associated with the user) in creating and/or listening to customized podcasts in one or more languages. Alternatively and/or additionally, the disclosed subject matter may assist the user in understanding points (e.g., main points) of an article (and/or a story and/or a set of content items) by automatically providing the user with a customized podcast with a desired length without having to speed up audio in the customized podcast (e.g., speeding up audio of a podcast may worsen listener comprehension).

Alternatively and/or additionally, implementation of at least some of the disclosed subject matter may enable a computer (e.g., a computer on which at least some of the content system is implemented) to automatically produce a customized podcast comprising accurate and/or realistic audio to convey points (e.g., main points) of an article (and/or a set of content items).

Alternatively and/or additionally, implementation of at least some of the disclosed subject matter may lead to benefits including increasing an accuracy and/or precision in transmitting requested and/or desired content to a user (e.g., as a result of at least one of (i) enabling a user to select customizing features in association with a request for a customized podcast, (ii) automatically determining a set of content items with information relevant to the customized podcast, (iii) automatically generating a summary of the set of content items based upon the customizing features, (iv) automatically generating the customized podcast to comprise an auditory representation of the summary, (v) providing the customized podcast to the user, etc.).

Alternatively and/or additionally, implementation of at least some of the disclosed subject matter may lead to benefits including automation of podcast creation tasks and/or less manual effort (e.g., as a result of generating the customized podcast automatically, wherein manual editing to produce the customized podcast is not required because at least one of (i) the set of content items with information relevant to the customized podcast is automatically determined, (ii) the summary of the set of content items is automatically generated based upon the customizing features, (iii) the customized podcast is automatically generated to comprise the auditory representation of the summary, etc.). For example, implementation of at least some of the disclosed subject matter may improve computer-implemented podcast creation through the use of rules, processes and/or techniques disclosed herein to enable the automation of podcast creation (which previously could not be automated) in a manner that is accurate and realistic, without requiring human creators that would rely on subjective determinations (and not the rules, processes and/or techniques disclosed herein) to manually produce and/or assemble the components of such a podcast.

In some examples, at least some of the disclosed subject matter may be implemented on a client device, and in some examples, at least some of the disclosed subject matter may be implemented on a server (e.g., hosting a service accessible via a network, such as the Internet).

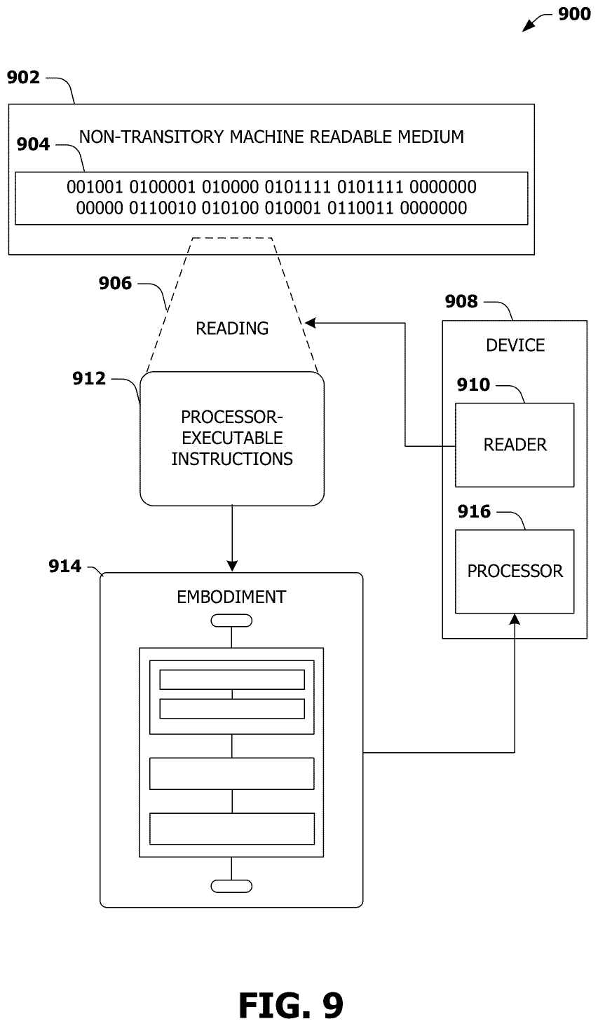

FIG. 9 is an illustration of a scenario 900 involving an example non-transitory machine readable medium 902. The non-transitory machine readable medium 902 may comprise processor-executable instructions 912 that when executed by a processor 916 cause performance (e.g., by the processor 916) of at least some of the provisions herein (e.g., embodiment 914). The non-transitory machine readable medium 902 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disc (CD), digital versatile disc (DVD), or floppy disk). The example non-transitory machine readable medium 902 stores computer-readable data 904 that, when subjected to reading 906 by a reader 910 of a device 908 (e.g., a read head of a hard disk drive, or a read operation invoked on a solid-state storage device), express the processor-executable instructions 912. In some embodiments, the processor-executable instructions 912, when executed, cause performance of operations, such as at least some of the example method 400 of FIG. 4, at least some of the example method 700 of FIG. 7, and/or at least some of the example method 800 of FIG. 8, for example. In some embodiments, the processor-executable instructions 912 are configured to cause implementation of a system, such as at least some of the exemplary system 501 of FIGS. 5A-5H, for example.

### 3. Usage of Terms

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer and/or machine readable media, which if executed will cause the operations to be performed. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
receiving a request to provide a podcast to a client device, wherein the request is indicative of a podcast customizing feature;
determining, based upon the request, a set of content items;
generating a summary of the set of content items based upon the podcast customizing feature;
generating the podcast to comprise an auditory representation of the summary; and
providing the podcast to the client device.

2. The method of claim 1, comprising:
providing, for display on the client device, a content interface providing a first content item and a podcast customization interface, wherein:
the podcast customization interface comprises a first selectable input associated with generating the podcast;
the request is received in response to a selection of the first selectable input;
the request is indicative of the first content item; and
the set of content items comprise the first content item.

3. The method of claim 2, wherein:
the first content item comprises a first article.

4. The method of claim 2, wherein:
the podcast customizing feature is received via the podcast customization interface.

5. The method of claim 1, wherein:
the podcast customizing feature comprises a target length of the podcast.

6. The method of claim 5, comprising:
determining a target summary length based upon the target length; and
submitting an indication of the target summary length to a language model, wherein generating the summary is performed using the language model based upon the target summary length.

7. The method of claim 1, wherein:
the podcast customizing feature comprises an entity of interest associated with the podcast;
determining the set of content items comprises:
analyzing a database of content items to identify a first content item comprising first information associated with the entity of interest; and
including the first content item in the set of content items; and
generating the summary of the set of content items comprises including, in the summary, a set of text indicative of at least some of the first information associated with the entity of interest.

8. The method of claim 1, wherein:
generating the podcast comprises converting the summary to the auditory representation of the summary using a text-to-speech converter.

9. The method of claim 1, wherein:
the podcast customizing feature comprises a level of detail of the podcast.

10. The method of claim 1, wherein:
the podcast customizing feature comprises an audience competency level associated with the podcast.

11. A computing device comprising:
a processor; and
memory comprising processor-executable instructions that when executed by the processor cause performance of operations, the operations comprising:
receiving a request to provide a podcast to a client device, wherein the request is indicative of:
an article; and
a podcast customizing feature;
generating a summary of the article based upon the podcast customizing feature;
generating the podcast to comprise an auditory representation of the summary; and
providing the podcast to the client device.

12. The computing device of claim 11, the operations comprising:
providing, for display on the client device, a content interface comprising the article and a podcast customization interface, wherein:
the podcast customization interface comprises a first selectable input associated with generating the podcast; and
the request is received in response to a selection of the first selectable input.

13. The computing device of claim 12, wherein:
the podcast customizing feature is received via the podcast customization interface.

14. The computing device of claim 11, wherein:
the podcast customizing feature comprises a target length of the podcast.

15. The computing device of claim 14, the operations comprising:
determining a target summary length based upon the target length; and
submitting an indication of the target summary length to a language model, wherein generating the summary is performed using the language model based upon the target summary length.

16. A non-transitory machine readable medium having stored thereon processor-executable instructions that when executed cause performance of operations, the operations comprising:
receiving a request to provide a first podcast to a client device, wherein the request is indicative of:
a second podcast; and
a podcast customizing feature;
generating a summary of the second podcast based upon the podcast customizing feature;
generating the first podcast to comprise an auditory representation of the summary; and
providing the first podcast to the client device.

17. The non-transitory machine readable medium of claim 16, the operations comprising:
converting audio of the second podcast to a transcript, wherein generating the summary of the second podcast is performed using the transcript.

18. The non-transitory machine readable medium of claim 17, wherein:
the podcast customizing feature comprises a target length of the first podcast.

19. The non-transitory machine readable medium of claim 18, the operations comprising:
determining a target summary length based upon the target length; and
submitting an indication of the target summary length to a language model, wherein generating the summary is performed using the language model based upon the target summary length.

20. The non-transitory machine readable medium of claim 16, wherein:
generating the first podcast comprises converting the summary to the auditory representation of the summary using a text-to-speech converter.
